(19) United States
(12) Patent Application Publication
(10) Pub. No.: US 2013/0265237 A1
(43) Pub. Date: Oct. 10, 2013

(54) SYSTEM AND METHOD FOR MODIFYING CONTENT DISPLAY SIZE

(71) Applicants: Seyed Behdad Esfahbod MirHosseinZadeh Sarabi, Toronto (CA); Wojciech Baranowski, Gdynia (PL)

(72) Inventors: Seyed Behdad Esfahbod MirHosseinZadeh Sarabi, Toronto (CA); Wojciech Baranowski, Gdynia (PL)

(73) Assignee: Google Inc., Mountain View, CA (US)

(21) Appl. No.: 13/439,786

(22) Filed: Apr. 4, 2012

(51) Int. Cl. G06F 3/041

(52) U.S. Cl. 345/173

(57) ABSTRACT

A system and method for modifying content display size on an electronic device that includes a touchscreen are provided. A multi-tap interaction with a touchscreen of the electronic device, the multi-tap interaction including plural presses, where each press of the plural presses occurs at a different time, such that a previous of the plural presses completes before a subsequent of the plural presses begins, is detected on the touchscreen electronic device. A determination of whether the last of the plural presses is maintained for at least a predetermined amount of time is made. In case where the last press is maintained for at least the predetermined amount of time, modification of the content display size for the touchscreen is activated, a slide interaction with the touchscreen is detected, and content display size for the touchscreen is modified in response to the detected slide interaction with the touchscreen.

### FIELD

The subject technology generally relates modifying content, and in particular, relates to modifying content display size.

### BACKGROUND

Electronic devices may be compatible with one or more zoom/shrink features that magnifies and/or reduces display size of content displayed on the electronic devices. However, users may have difficulty utilizing zoom/shrink features, particularly for mobile devices where the users are in motion.

### SUMMARY

The disclosed subject technology relates to a computer-implemented method for modifying content display size on an electronic device comprising a touchscreen. The method comprises detecting, on a touchscreen of the electronic device, a multi-tap interaction with the touchscreen electronic device, the multi-tap interaction comprising plural presses, wherein each press of the plural presses occurs at a different time, such that a previous of the plural presses completes before a subsequent of the plural presses begins. The method further comprises determining whether the last of the plural presses is maintained for at least a predetermined amount of time. In a case where the last press is maintained for at least the predetermined amount of time, the method further comprises activating modification of content display size for the touchscreen, detecting, after activation of the modification of the content display size, a slide interaction with the touchscreen, and modifying the content display size for the touchscreen in response to the detected slide interaction with the touchscreen.

The disclosed subject matter further relates to a system for modifying content display size on an electronic device comprising a touchscreen. The system comprises one or more processors, and a machine-readable medium comprising instructions stored therein, which when executed by the processors, cause the processors to perform operations comprising detecting, on a touchscreen of the electronic device, a multi-tap interaction with the touchscreen electronic device, the multi-tap interaction comprising plural presses, wherein each press of the plural presses occurs at a different time, such that a previous of the plural presses completes before a subsequent of the plural presses begins. The operations further comprise determining whether the last of the plural presses is maintained for at least a predetermined amount of time. In a case where the last press is maintained for at least the predetermined amount of time, the operations further comprise activating modification of content display size for the touchscreen, detecting, after activation of the modification of the content display size, a slide interaction with the touchscreen, and performing a zoom operation on the content in response to the detected slide interaction with the touchscreen, wherein content display size is increased in response to a upward slide interaction with the touchscreen and wherein content display size is decreased in response to a downward slide interaction with the touchscreen.

The disclosed subject matter further relates to a machine readable medium comprising instructions stored therein, which when executed by a system, cause the system to perform operations comprising detecting, on a touchscreen of the electronic device, a double-tap interaction with the touchscreen electronic device, the double-tap interaction comprising two presses; wherein the first press of the two presses completes before the second press of the two presses begins. The instructions further comprise determining whether the second of the two presses is maintained for at least a predetermined amount of time. In a case where the second press is maintained for at least the predetermined amount of time, the instructions further comprise activating modification of content display size for the touchscreen, detecting, after activation of the modification of the content display size, a slide interaction with the touchscreen, and performing a zoom operation on the content in response to the detected slide interaction with the touchscreen, wherein content display size is increased in response to a upward slide interaction with the touchscreen and wherein content display size is decreased in response to a downward slide interaction with the touchscreen. In a case where the last press is not maintained for at least the predetermined amount of time, the instructions further comprise modifying the content display size for the touchscreen by a preset amount.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example distributed network environment which can modify content display size on an electronic device.

FIG. 2 illustrates an example process by which content display size is modified on an electronic device.

FIG. 3A illustrates a first example sequence of screenshots for modifying content display size on a smartphone device.

FIG. 3B illustrates a second example sequence of screenshots for modifying content display size on a smartphone device.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In accordance with the subject technology, a system and a method for modifying content display size are provided. The system may allow a user to use one finger to activate a zoom feature to modify the display size of content displayed on a user's touchscreen electronic device. This would allow the user to augment and/or reduce the display size of content on the user's electronic device while the user is in motion with less hassle. Touchscreen electronic devices include any electronic device that can receive a user action (e.g., a swipe action, a tap action, etc.) through a touchscreen associated with the respective electronic devices. Touchscreen electronic devices may include smartphones, tablet computers, desktop computers, laptop computers, etc.

The user may activate a zoom feature by double tapping a touchscreen electronic device's display screen with one finger, where each tap of the double tap occurs at a different time, such that the first tap of the double tap completes before the second tap of the double tap begins, and subsequently holding the finger on the display screen for at least a predetermined period of time after the second tap. The predetermined period of time may be user designated. Alternatively, the predetermined period of time may be preset on the electronic device.

The user, upon activation of the zoom feature, may enlarge the display size of content displayed on the display screen of the user's touchscreen electronic device by sliding the user's finger upwards. Magnification of content display size may be directly proportional to the amount of time the user's finger slides upwards from the finger's location after the second tap, or to the distance the user's finger slides across the display screen of the touchscreen electronic device.

The user, upon activation of a zoom feature, may also reduce the display size of content displayed on the display screen of the user's touchscreen electronic device by sliding the user's finger downwards. Reduction of content display size may also be directly proportional to the amount of time the user's finger slides downwards from the finger's location after the second tap, or the distance the user's finger slides across the display screen of the user's touchscreen electronic device.

Alternatively, the disclosed subject matter may allow the user may activate the zoom feature by tapping on the user's touchscreen electronic device with one finger for a different number of times (i.e., more than two times) followed by holding the finger for at least a predetermined period of time. Furthermore, the disclosed subject matter may also allow the user to activate the zoom feature by simultaneously tapping on the user's touchscreen electronic device with two or more fingers for a preset number of times followed by holding the two or more fingers for at least a predetermined period of time.

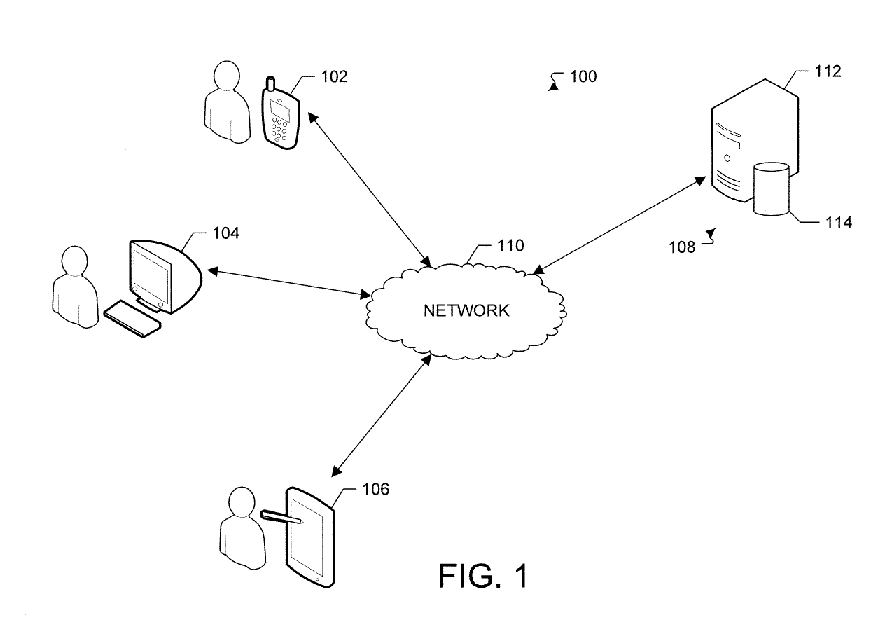

FIG. 1 illustrates an example distributed network environment which can modify content display size on an electronic device. A network environment 100 includes a number of touchscreen electronic devices 102-106 communicably connected to a server 108 by a network 110. Server 108 includes a processing device 112 and a data store 114. Processing device 112 executes computer instructions stored in data store 114, for example, to provide display content to any of touchscreen electronic devices 102-106.

In some example aspects, each of the touchscreen electronic devices 102-106 may be any machine with appropriate hardware and software to modify content display size in response to a slide interaction with the display screen of the respective touchscreen electronic devices. Touchscreen electronic devices 102-106 can be mobile devices (e.g., smartphones, tablet computers, PDAs, and laptop computers), portable media players, desktop computers or other appropriate computing devices. In the example of FIG. 1, touchscreen electronic device 102 is depicted as a smartphone, touchscreen electronic device 104 is depicted as a desktop computer, and touchscreen electronic device 106 is depicted as a tablet computer.

In some example aspects, each of the touchscreen electronic devices 102-106 may detect a multi-tap interaction with their respective display screens. A multi-tap interaction may include pressing the touchscreen of one of the electronic devices 102-106 at least two times, where each press of the multi-tap interaction occurs at a different time, such that a previous of press action completes before a subsequent press action begins, and maintaining the last press for a predetermined amount of time. Furthermore, each of the touchscreen electronic devices 102-106 may determine whether the last of the multi-tap interaction is maintained for at least a predetermined amount of time. Furthermore, each of the touchscreen electronic devices 102-106 may activate modification of content display size based on the detected multi-tap interaction with their respective display screens. Upon activation of modification of content display size, each of the touchscreen electronic devices 102-106 may detect a slide interaction with the touchscreen. Furthermore, each of the touchscreen electronic devices 102-106 may modify the content display size of the touchscreen in response to the detected slide interaction with the touchscreen.

Content may include an image (e.g., a map, a graph, a picture, etc.). The content may also include text (e.g., a document, an article, etc.). Content may be transmitted from server 108 via the network 110 to the touchscreen electronic devices. Content may also be stored in a storage component (e.g., hard disk, RAM, ROM, etc.) of the respective touchscreen electronic devices.

Furthermore, each of the touchscreen electronic devices 102-106 may modify the content display size in response to a slide interaction with the respective touch screen electronic devices.

Server 108 may be any system or device having a processor, a memory, and communications capability for providing content to the touchscreen electronic devices. In some example aspects, server 108 can be a single computing device such as a computer server. In other embodiments, server 108 can represent more than one computing device working together to perform the actions of a server computer (e.g., cloud computing).

Network 110 can include, for example, any one or more of a cellular network, a satellite network, a personal area network (PAN), a local area network (LAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

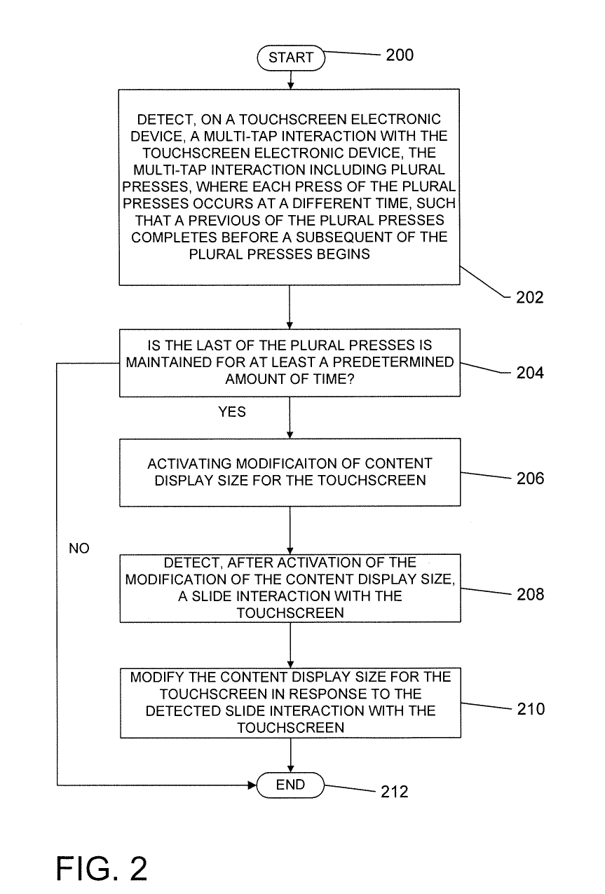

FIG. 2 illustrates an example process by which content display size is modified on an electronic device. At start block 200, content is provided for display on a display screen associated with a touchscreen electronic device. A touchscreen electronic device may be any machine with appropriate hardware and software to modify content display size in response to a slide interaction with the display screen of the touchscreen electronic device. The provided content may include an image (e.g., a map, a graph, a picture, etc.). The provided content may also include text (e.g., a document, an article, etc.). At step 202, a multi-tap interaction with a touchscreen electronic device, the multi-tap interaction including plural presses, where each press of the plural presses occurs at a different time, such that a previous of the plural presses completes before a subsequent of the plural presses begins; is detected on the touchscreen electronic device. A press may include a physical interaction with the display screen with one finger. A press may include a simultaneous interaction with the display screen with two or more fingers. A press may include additional physical interactions with the display screen that can be detected by the electronic device.

The multi-tap interaction may include pressing against a display screen of the touchscreen electronic device two times and maintaining a second press for at least a predetermined amount of time. Each press of the two presses may occur at a different time, where the first press of the two presses completes before the second press of the two presses begins. The multi-tap interaction may also include pressing at least two fingers simultaneously against a display screen of the touchscreen electronic device two times and maintaining a second press for at least a predetermined time. The multi-tap interaction may also include pressing the touchscreen of the electronic device a different plurality of times (e.g., more than two), such that a previous of the plural presses completes before a subsequent of the plural presses begins, and maintaining the last of the plural presses for a predetermined time. The predetermined amount of time may be user designated.

At step 204, in case the electronic device detects the last of the plural presses is maintained for at least a predetermined amount of time, the electronic device may activate modification of content display size on the touchscreen in step 206. Otherwise, the process may proceed to end block 212 as shown in FIG. 2. Alternatively, in case the last press is not maintained for at least the predetermined amount of time, content display size may be modified by a preset amount.

In case the last press is maintained for at least the predetermined amount of time, modification of the content display size for the touchscreen is activated in step 206. At step 208, the electronic device detects a slide interaction with the touchscreen and activates modification of the provided content's display size based on the detected multi-tap interaction. The slide action may include an upward slide interaction and a downward slide interaction. Where the multi-tap interaction includes pressing the display screen with one finger, the slide action may include sliding upwards or downwards with the one finger. Where the multi-tap interaction includes simultaneously pressing the display screen with two or more fingers, the slide action may include sliding upwards or downwards with at least one of the two or more fingers. At step 210, content display size is modified in response to the slide interaction with the touchscreen. Modifying the content display size may include increasing the display size of the touchscreen in response to an upward slide interaction with the touchscreen. Modification of the content display size may include decreasing the display of the content in response to a downward slide interaction with the touchscreen.

Modification of the content display size may include modifying the display size in response to sliding at least one of two or more fingers away from remaining of the two or more fingers while maintaining a pressing action with the two or more fingers against the display screen of the touchscreen electronic device. For example, content display size may increase in response to sliding at least one of the two or more fingers upwards and away from the remaining of the two or more fingers while maintaining a pressing action with the two or more fingers against the display screen of the touchscreen electronic device. Content display size may decrease in response to sliding at least one of the two or more fingers downwards and away from the remaining of the two or more fingers while maintaining a pressing action with the two or more fingers against the display screen of the touchscreen electronic device. The process then ends at end block 212.

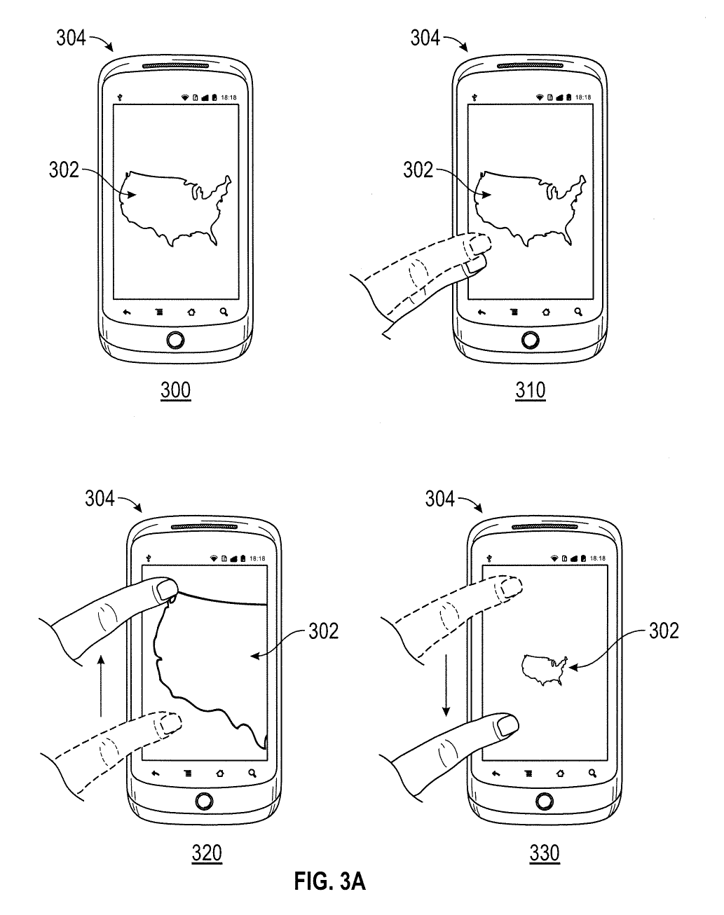

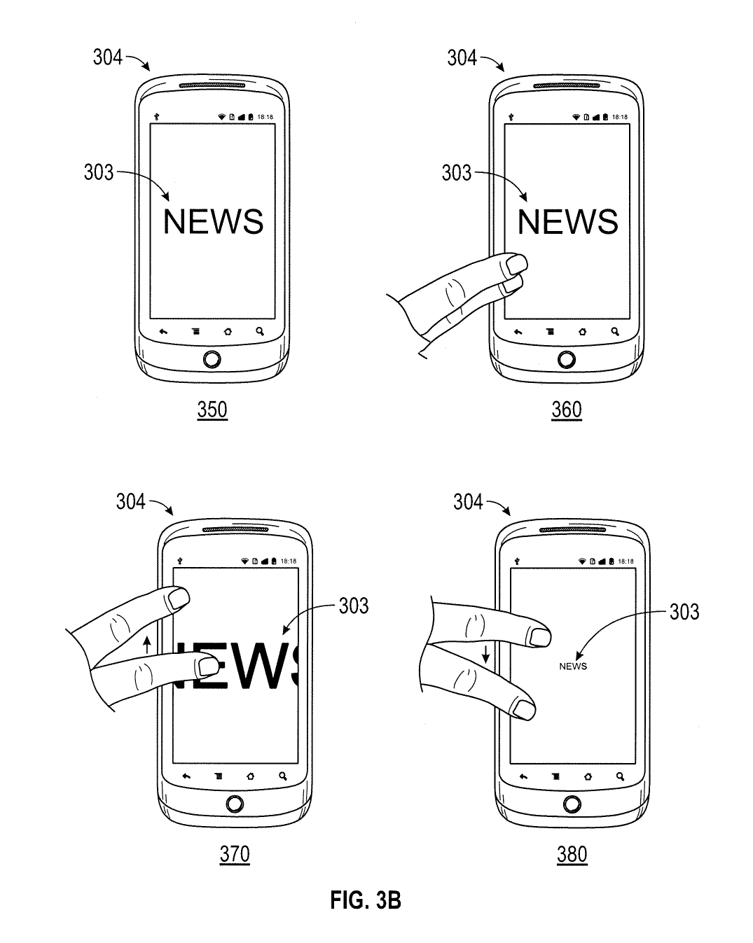

FIG. 3A illustrates a first example sequence of screenshots for modifying content display size on a smartphone device. Screenshot 300 illustrates an image (e.g., a map, a graph, a picture, etc.) 302 that is provided for display on a display screen associated with a smartphone 304. Screenshot 310 illustrates a user of the smartphone device 304 tapping on the smartphone device two times with one finger while maintaining a press action with respect to the smartphone's display screen for at least a predetermined amount of time. The predetermined amount of time may be user designated. Upon pressing the display screen of the smartphone device 304 twice with the one finger and holding the second press for at least a predetermined amount of time, modification of the image display is activated. Activation of modification of the image display size may be based on detection of additional variations of multi-tap interactions described herein.

Screenshot 320 illustrates the user of the smartphone device 304 increasing the image's display size by sliding the one finger upwards while maintaining the second press against the display screen of the smartphone 304. The user may release the user's finger from the display screen of the smartphone 304 after the user is satisfied with the adjusted content display size. The user may continue to slide the user's finger upwards to further increase the display size of the image 302.

Screenshot 330 illustrates the user of the smartphone device 304 decreasing the image's display size by sliding the one finger downwards while maintaining the second press against the display screen of the smartphone 304. If the user wishes to decrease display size of the image, the user may continue to step 330. The user may release the user's finger from the display screen of the smartphone device after the user is satisfied with the adjusted content display size. Alternatively, the user may continue to slide the user's finger downwards to further decease the display size of the image 302.

FIG. 3B illustrates a second example sequence of screenshots for modifying content display size on a smartphone device. Screenshot 350 illustrates an textual article that is provided for display on a display screen associated with a smartphone 304. Screenshot 360 illustrates a user of the smartphone device 304 simultaneously tapping on the smartphone device two times with at least two fingers. Upon pressing the display screen of the smartphone device 304 twice with the at least two fingers and holding the second press for at least a predetermined amount of time, modification of content display is activated. Activation of medication of content display size may be based on detection of additional variations of multi-tap interactions described herein.

Screenshot 370 illustrates the user of the smartphone device 304 increasing the textual article's display size by sliding at least one finger of the at least two fingers upwards and away from remaining of the at least two fingers while maintaining the second press against the display screen of the smartphone. The user may release the user's fingers from the display screen of the smartphone device after the user is satisfied with the adjusted content display size. The user may continue to slide the at least one finger of the at least two fingers upwards and away from remaining of the at least two fingers to further increase the display size of the textual article 303.

Screenshot 380 illustrates the user of the smartphone device 304 decreasing the textual article's display size by sliding at least one finger downwards and away from remaining of the two or more fingers while maintaining the second press against the display screen of the smartphone. The user may release the user's fingers from the display screen of the smartphone device after the user is satisfied with the adjusted content display size. The user may continue to slide the at least one finger of the at least two fingers downwards and away from remaining of the at least two fingers to further increase the display size of the textual article 303.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

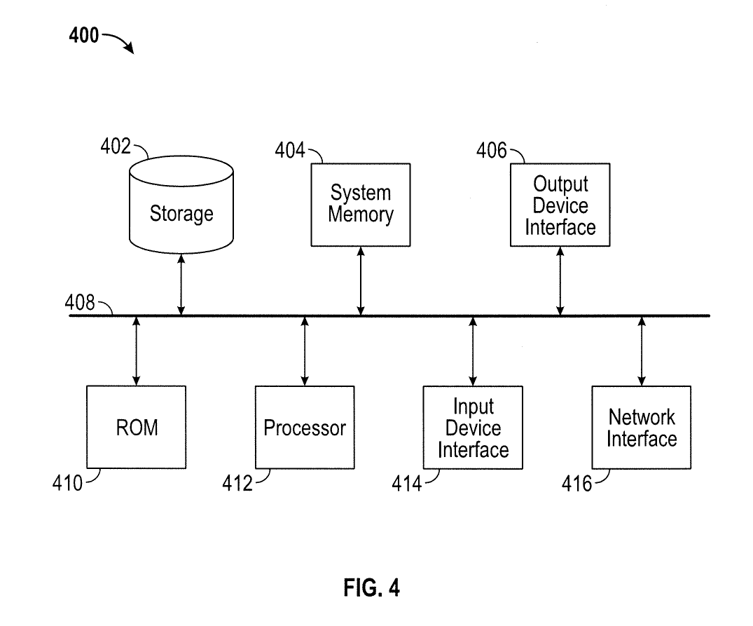

FIG. 4 conceptually illustrates an electronic system with which some implementations of the subject technology are implemented. Electronic system 400 can be a laptop computer a desktop computer, smartphone, PDA, a tablet computer or any other sort of device 102-106. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for modifying content display size in accordance with some implementations. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's electronic device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a electronic device (e.g., for purposes of displaying data to and receiving user input from a user interacting with the electronic device). Data generated at the electronic device (e.g., a result of the user interaction) can be received from the electronic device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method, the method comprising:
receiving, at a computing device, an indication of a multi-tap interaction with an input device, the multi-tap interaction comprising plural presses, wherein each press of the plural presses occurs at a different time, such that a previous of the plural presses completes before a subsequent of the plural presses begins;
determining, by the computing device, whether a final press of the plural presses is maintained for at least a predetermined amount of time; and
responsive to determining, by the computing device, that the last press is maintained for at least the predetermined amount of time;
activating, by the computing device, modification of content display size;
receiving, at the computing device, after activation of the modification of the content display size, an indication of a slide interaction with the input device; and
modifying, by the computing device, the content display size in response to receiving the indication of the slide interaction with the input device.

2. The computer-implemented method of claim 1, further comprising:
responsive to determining that the final press is not maintained for at least the predetermined amount of time, modifying the content display size by a preset amount.

3. The computer-implemented method of claim 1, wherein the plural presses comprise two presses, and wherein the final press is the second of the two presses.

4. The computer-implemented method of claim 1, wherein the slide interaction comprises an upward slide interaction, and wherein modifying the content display size comprises increasing the content display size.

5. The computer-implemented method of claim 1, wherein the slide interaction comprises a downward slide interaction, and wherein the modifying the content display size comprises decreasing the content display size.

6. The computer-implemented method of claim 2, wherein the predetermined amount of time is user designated.

7. The computer-implemented method of claim 1, wherein each press of the plural presses corresponds to a single finger press.

8. The computer-implemented method of claim 1, wherein each press of the plural presses corresponds to a double finger press.

9. The computer-implemented method of claim 1, wherein the computing device is a smartphone.

10. The computer-implemented method of claim 1, wherein the content is an image.

11. The computer-implemented method of claim 1, wherein the content comprises text.

12. A system, comprising:
one or more processors; and
a machine-readable medium comprising instructions stored therein, which when executed by the processors, cause the system to perform operations comprising:
receiving an indication of a multi-tap interaction with an input device, the multi-tap interaction comprising plural presses, wherein each press of the plural presses occurs at a different time, such that a previous of the plural presses completes before a subsequent of the plural presses begins;
determining whether the final press of the plural presses is maintained for at least a predetermined amount of time; and
responsive to determining that the final press is maintained for at least the predetermined amount of time;
activating modification of content display size;
receiving, after activation of the modification of the content display size, an indication of a slide interaction with the input device; and
performing a zoom operation on the content in response to receiving the indication of the slide interaction with the input device, increasing the content display size in response to determining that the slide interaction comprises an upward slide interaction and decreasing the content display size in response to determining that the slide interaction comprising a downward slide interaction.

13. The system of claim 12, further comprising:
responsive to determining that the last press is not maintained for at least the predetermined amount of time, modifying the content display size by a preset amount.

14. The system of claim 12, wherein the plural presses comprise two presses, and wherein the final press is the second of the two presses.

15. The system of claim 12, wherein the predetermined amount of time is user designated.

16. The system of claim 12, wherein each of the plural presses corresponds to a single finger press.

17. The system of claim 12, wherein each of the plural presses corresponds to a double finger press.

18. The system of claim 12, wherein the content is an image.

19. The system of claim 12, wherein the content comprises text.

20. A non-transitory computer readable medium comprising instructions stored therein, which when executed by a system, cause the system to perform operations comprising:
responsive to receiving an indication of a double-tap interaction with an input device, the double-tap interaction comprising two presses, wherein the first press of the two presses completes before the second press of the two presses begins;
determining whether the second of the two presses is maintained for at least a predetermined amount of time; and
responsive to determining that the second press is maintained for at least the predetermined amount of time;
activating modification of content display size;
receiving an indication, after activation of the modification of the content display size, of a slide interaction with the input device; and
performing a zoom operation on the content in response to receiving the indication of the slide interaction, wherein the content display size is increased in response to determining that the slide interaction comprises an upward slide interaction and wherein the content display size is decreased in response to determining that the slide interaction comprises a downward slide interaction; and
responsive to determining that the second press is not maintained for at least the predetermined amount of time, modifying the content display size by a preset amount.

21. The computer-implemented method of claim 1, wherein the plural presses comprise more than two presses and the final press is the last of the more than two presses.

22. The system of claim 12, wherein the plural presses comprise more than two presses and the final press is the last of the more than two presses.

23. The computer-implemented method of claim 1, wherein the input device comprises a touchscreen.

24. The system of claim 12, wherein the input device comprises a touchscreen.

25. The non-transitory computer readable medium of claim 20, wherein the input device comprises a touchscreen.
